(19) United States
(12) Patent Application Publication
(10) Pub. No.: US 2024/0118884 A1
(43) Pub. Date: Apr. 11, 2024

(54) AUTOMATED DEPLOYMENT METHOD FOR UPGRADING CLIENT'S INTERNAL BUSINESS SOFTWARE SYSTEMS

(71) Applicant: ZHEJIANG FINGARD TECHNOLOGY CO., LTD., Hangzhou (CN)

(72) Inventors: Zhiqiang LIU, Hangzhou (CN); Enwei BAO, Hangzhou (CN); Yulin WU, Hangzhou (CN)

(73) Assignee: ZHEJIANG FINGARD TECHNOLOGY CO., LTD., Hangzhou (CN)

(21) Appl. No.: 18/378,348

(22) Filed: Oct. 10, 2023

(30) Foreign Application Priority Data
Oct. 10, 2022 (CN) 202211231174X

(51) Int. Cl. G06F 8/65; G06F 8/71; G06F 16/28

(52) U.S. Cl. CPC G06F 8/65; G06F 8/71; G06F 16/284

(57) ABSTRACT

An automated deployment method for upgrading a client's internal business software system includes: obtaining a configuration template from a runtime configuration of a business software system, unifying and updating a format of the configuration template; automatically adjusting middleware using the obtained configuration template; and performing fast cross-version upgrading. Compared with existing technologies, the method realizes automatic generation of the configuration template and reduces the demand on professional skill of the field operators. Irrespective of upgrading by direct connection to the upgrade server of the service provider or upgrading directly at the client site, the method is faster and more resource-saving than existing technologies.

### FIELD

The subject matter described herein relates to computer technologies, and more particularly relates to an automated deployment method for upgrading a client's internal business software systems.

### BACKGROUND

Dedicated internal business software systems are essential to a modern company, for example a large financial enterprise, which are deployed to facilitate internal business communications. With enterprise growth, business expansion, as well as iterative development of the internal business software systems of an enterprise, its business software systems need to be frequently upgraded to target versions such that users can access the latest functions. It is noted that, to enhance data security and facilitate internal control, the internal software systems of large financial enterprises are generally privately networked and isolated from external networks. Therefore, to upgrade the internal business software systems, a system program developer needs to prepare various files for the upgrade, including, but not limited to, front-end files, back-end packages, configuration files, and database SQL scripts, and then the system program developer needs to prepare go-live documents setting forth operating procedures, such that an operation engineer of the enterprise could perform configuration and execute concerned programs based on the go-live documents.

Here, the quality for the go-live documents depends on the programming level for the system program developer. Once the go-live documents for upgrading are illiterate to the operation engineer due to bad programming, the upgrade would be unable to proceed. Even if the operation engineer could fully understand the go-live documents but lacks sufficient skills, particularly know-hows on installing various middleware or troubleshooting during the installation process, the upgrade is still likely to fail. Even if the operation engineer completes system upgrade, the manual upgrading approach is still inefficient and error-prone, deteriorating client experience. In addition, due to so many business functions to upgrade, more operation engineers would be engaged, increasing overheads of the enterprise.

Existing technologies have already provided solutions for automatic software installation or upgrade. For example, the Chinese Patent No. CN201010282302.4 titled “Method and System for Automatically Installing Application Software” discloses a method and system for automatically installing application software. The method comprises: S1. starting a source operating system; S2. initiating, by the source operating system, a system identification program to automatically identify system information of a target operating system; S3. initiating, by the source operating system, an auto-configuration program based on the system information of the target operating system to perform system-adaptive, automatic configuration for installing a target application software, thereby generating a target configuration file; S4. initiating, by the source operating system based on the target configuration file, an installer of the target application software to automatically install the target application software on the target operating system. By implementing the method and system for automatically installing application software disclosed thereby, users can correctly and automatically install the application software even without sophisticated knowledge of computers. Furthermore, the system and method disclosed thereby can be utilized for correct, automatic installation of application software on a target device hosting a plurality of target operating systems. However, the solution is only directed to installing a single piece of application software in an OS (Operating System)-based environment, but not directed to complete deployment of a very large business software system with various functions involving front-end programs, back-end programs, micro services, middleware, caching, databases, message queue, file systems, etc. Therefore, such a technical solution is not applicable to holistic system configuration.

Another solution is disclosed in the Chinese Invention Patent No. CN201010572412.4 titled “Automated configuration of computer-specific software updates.” The software update system as described automatically performs configuration of a software update approved by the vendor of a process control system on a host that executes the process control system. The software update system comprises a client application and a server application, where the client application is configured to generate a software update request useful to the host and to initiate automated configuration of software update with respect to the host, and the server application is configured to provide software update data to the client application in response to the request.

However, such a solution is based on the client/server mode, which requires the client to initiate a network request to access a remote server before performing upgrading. This solution is restricted by security measures of many clients particularly those clients in financial sectors, who are isolated from external networks. Even if external networks are enabled, upgrade softwares of various versions still need to be downloaded one by one. Due to the large sizes of packages to download as well as so much duplicate data included therein, system updating is still inefficient.

### SUMMARY

To overcome the above-mentioned and other drawbacks and problems in existing technologies, the disclosure provides an automated deployment method for upgrading a client's internal business software system. Irrespective of whether the client's system is allowed for external networks and irrespective of the professional level of the client's operation engineer, the disclosure can still implement highly automated update of a complex business software system.

In this respect, an automated deployment method for upgrading a client's internal business software system comprises: obtaining a configuration template from a runtime configuration of a business software system, updating a format of the configuration template, replacing the updated configuration template with a live runtime configuration, and upgrading the system based on the updated, templated, runtime configuration.

The upgrading comprises: detecting and analysizing a deployment environment where the business software system is hosted; updating the runtime configuration based on the configuration template; obtaining a release file, wherein in a case of middleware upgrade, the existing runtime configuration of the business software system in the deployment environment and a middleware-related configuration are compared with a middleware portion of a configuration file in a directory of the release file, where a comparison result includes three conditions: addition, modification, or deletion, and updating a value of the configuration template based on a specific condition. For the contents existing previously, whether they are changed is detected; those unchanged contents will not be repetitively upgraded. If the contents have been changed, the original contents are deleted while the contents of the new version are copied. A file not provided previously will be newly created. The contents existent previously but non-existent in the final version are deleted directly. All such information is input into the configuration template, and a database script included in the release file is executed.

The upgrading further comprises: writing back configuration, transmitting configuration information to the configuration center, making the configuration information effective, identifying a front-end program file and a back-end program file for the upgrading by comparing pre-upgrading static directory and post-upgrading static directory; downloading files used for the upgrading accurately, and then performing upgrading; subjecting the deployment environment to health detection upon completion of the upgrading; and saving, in a case that a detection result satisfies health criteria, the upgraded configuration template.

Simply put, the disclosure comprises three core actions:
1. obtaining a configuration template from a runtime configuration of the business software system, and unifying and updating a format of the configuration template, wherein a method of unifying and updating the format of the configuration template comprises:
   obtaining an existing configuration template in the deployment environment;
   parsing the existing configuration template to identify a configuration format thereof;
   and determining, in a case that a configuration item in the configuration format is of a structure “class of configuration business—type of configuration database—number of configuration database—attribute of configuration value”, that the configuration template has been updated; otherwise, modifying the configuration item in the configuration format to the configuration template with the structure “class of configuration business—type of configuration database—number of configuration database—attribute of configuration value”.

The importance for this step lies in that the client could upgrade a large business software system with complex and numerous functions, among which various functions are developed by a plurality of teams. Individual developers generally consider the consistency and logic of the codes of their own parts during the development process, such that they cannot coordination with other teams and much less consideration is made to specific deployment issues. Therefore, a conventional configuration manner is of a Key=Value mode, where Key refers to a key word, and Value refers to a value; in a configuration file, the value is assigned based on the key word. Therefore, the existing mode provides no contemplation on the automated deployment described in the disclosure. The Keys used in different teams are not uniform and of messy formats. However, the disclosure unifies the configuration items, which guarantees enablement of the subsequent automatic configuration operation. In addition, the previous non-uniform key values may also be unified by a tool.
2. On the basis of the preceding step, automatic adjustment of the middleware is directly implemented using the configuration template. This will be further described through example embodiments.
3. The method further enables fast cross-version upgrade, comprising:
   performing, at a database end, simulated upgrading sequentially as per version number via a SQL script till a target version, wherein a script of the target version and a pre-request script for executing the script are directly used, thereby omitting repetitive, redundant, or invalid scripts; during this procedure, changes of the middleware are recorded and marked, without actual execution based on the configuration template, and the contents which are previously added but deleted later are also marked and then canceled, thereby effectively shortening the upgrading procedure.
   during the upgrading, a front-end program and a back-end program are subjected to simulated deployment, wherein recording their current version numbers before the upgrading, recording files updated at each time of upgrading as per the version numbers till the target version, obtaining a list of changed static files by comparing the records, and then downloading the static files to physically deploy the target version.

Preferably, during the simulated upgrading, the configuration template and deployment status of the static files of each time of upgrading are saved by snapshots, and each time of upgrading references the snapshot of its preceding time of upgrading till the target version; all snapshots are saved during the upgrading and deleted upon completion of the upgrading and health detection.

Preferably, the detecting and analyzing a deployment environment where the business software system is hosted comprises: verifying the deployment environment to confirm that it is the deployment environment where the internal business software system of an authenticated client is hosted; performing version detection to obtain version information of the existing business software system in the deployment environment; and performing pre-upgrading health detection to confirm that the existing business software system runs normally. From the perspective of the service vendor, environment determination may guarantee that the upgrade operation is directed to a designated device, which may prevent losses to the service vendor caused by unauthenticated upgrading; in addition, it is verified whether the current deployment environment satisfies the criteria of system upgrade, such that smooth upgrading is guaranteed.

Preferably, during the pre-upgrading health detection with respect to the business software system, a known fault in the system is retrieved via a log file, and the known fault, after being digitalized, is checked with capability of an automatic repair program deployed for the current time of upgrading, so as to accurately determine health degree of the deployment environment, wherein in a case that the health degree does not meet criteria, the known fault is repaired before upgrading. Existing technologies also require detection of network condition, and for a deployment environment with a bad network condition, it is usually required to make sure that the deployment environment is free of faults before system upgrade. However, since the deployment environment where the to-be-upgraded business software system of a client is hosted generally has served a long time, there is no guarantee that the performance and running states of various devices would be maintained continuously healthy. In this case, a recommended solution would be replacing the hardware system; however, this will bring about a high cost and will also take some time for configuration, affecting upgrading of the business software system. Correspondingly, progressive development has also been made in existing technologies with respect to automatic fault handling softwares, such that during the pre-upgrading health detection procedure of the disclosure, an existing fault is first checked; if a tool provisioned by the service vendor can effectively mitigate such issues, even if it cannot be completely repaired, so long as it is determined not to affect system upgrading, the deployment environment may be deemed as healthy. Particularly for some devices with a longer service age, this setting can guarantee smooth proceeding of the upgrade.

Preferably, in a case that a plurality of devices are present in the deployment environment and a plurality of business software systems are hosted on each device, while what are to be upgraded are a part of the business software systems, after the configuration template is updated, an upgrade tool is run, device information of the devices to be upgraded is inputted, and then the business software systems to be upgraded on the devices are selected; the upgrade tool automatically detects version information of currently running business software systems; the business software systems to be upgraded as well as target version numbers are selected by a technician; after the deployment environment passes health detection, the upgrade tool starts upgrading of respective business software systems one by one. This procedure is carried out by a corresponding upgrade tool provisioned by the service vendor, facilitating the technician to manage the entire upgrading process in a complex upgrading environment.

Preferably, the automated deployment method for upgrading a client's internal business software system according to the disclosure further comprises performing load balancing on the deployment environment of the business software system after obtaining the release file, wherein traffics of middleware and back-end programs in the business software system are disabled before deployment starts; the traffics are monitored during upgrading to guarantee that no traffics are generated by the middleware and the back-end programs; and the traffics are re-enabled upon completion of the upgrading and end of the heath detection with respect to the deployment environment. During the system upgrading process, it is a general practice to allocate system resources to the configuration center as much as possible. However, since the business software systems adopted by the client in the disclosure generally do not allow operation interruption, load balancing needs to be carried out. The load balancing is implemented via a gateway of the configuration center, specifically by cutting off or intercepting dynamic traffics. By caching the data returned from the database, excessive traffic occupation by other transactions during the upgrading procedure may be prevented. In addition, dynamic traffic requests at the front end are temporarily ignored but recorded and pended via the cache of the front-end program, and those requests will be promptly handled as per request sequence when the traffics are re-enabled upon completion of system upgrading. This practice enables a smooth and stable upgrading procedure, offering a better experience to users of the business software system.

Preferably, in a case that the deployment environment is disabled from an external network, the configuration template is updated via a mobile memory medium, and then corresponding static files are copied from a system vendor based on the configuration template. In this way, when the deployment environment is disabled from the external network, the upgrade is realized via two steps: the first step is to obtain the configuration template for this upgrade via the operation configuration center, and the second step is to obtain the corresponding static files from the service vendor based on the configuration template. Although it is divided into two steps, the total upgrade duration and the data that needs to be transferred are both less than direct deployment in existing technologies. This may also reduce the total traffic of external programs accessing the network disconnected internal system.

Preferably, the upgrading further comprises: troubleshooting, wherein during the upgrading, an operation log is real-time displayed on a user interface of the configuration center, such that once a problem is detected in respective detecting procedures, upgrading is suspended, the upgrade tool is pending instantly, and alarm is triggered;
wherein a faulty phase is identified by a technician via the log, and one of options set forth below is selected based on log records and actual conditions of the deployment environment:
1) for a known problem, continuing deployment upon completion of manual repair;
2) for an unknown problem or a critical problem, rolling back to the upgrading phase to recover the states recorded by the preceding snapshot and then terminating the upgrading.

In this way, occurrence of a fault would not cause crash of the entire business software system, which is maintained as much as possible. Since the preceding state as snapshot is also an implementable state, if an emergent fault occurs, the upgrade may also roll back to the application of a lower version for emergency use, and after the fault is overcome, the upgrade is resumed.

Compared with existing technologies, the method according to the disclosure realizes automatic generation of the configuration template and reduces the demand on professional skill of the field operators. Although existing technologies may also realize one-click software upgrade, relevant environment of the software still relies on manual setting. Unlike a Windows operating system that can be installed on a conventional device, the business software systems referred to in the disclosure are deployed on various devices of different types in different environments; therefore, existing technologies cannot implement the automatic configuration manner disclosed herein. Irrespective of upgrading by direct connection to the upgrade server of the service provider or upgrading directly at the client's site, the method disclosed herein is faster and more resource-saving than existing technologies. In addition, the disclosure enables configuration-driven, automatic comparative analysis, unlike existing technologies which totally rely on manual configuration.

### BRIEF DESCRIPTION OF THE DRAWINGS

FIG. 1 is an overall systematic block diagram illustrating an automated deployment method for upgrading a client's internal business software system according to the disclosure;

FIG. 2 is a flow diagram of the automated deployment method for upgrading a client's internal business software system according to the disclosure;

FIG. 3 is a schematic diagram of a configuration format of a configuration template in existing technologies;

FIG. 4 is a schematic diagram of a configuration format employed in the automatic deployment method for upgrading a client's internal business software system according to the disclosure;

FIG. 5 is a schematic configuration diagram of the automatic deployment method for upgrading a client's internal business software system in a configuration environment accessible with an external network according to the disclosure.

### DETAILED DESCRIPTION

To facilitate those skilled in the art to understand, the disclosure will be described in further detail through detailed description with reference to the accompanying drawings.

The software deployment described herein may be applied to initial installation or upgrade of a business software system. Its main advantage lies in that during the upgrading process, a target-specific static file may be selected to be downloaded according to a configuration file, thereby reducing the number of files to be downloaded actually. Meanwhile, fast cross-version upgrade is also enabled via simulated upgrading. It is noted that the installation of a business software system referred to herein involves more than installing software. Its general process includes: setting a configuration template based on a deployment environment, and then performing middleware upgrade, back-end upgrade, front-end upgrade based on the configuration template. The middleware herein refers to a database, a cache, or a message queue. The back-end program refers to a supportive program running in background, such as Java. The front-end program refers to an interactive user interface, such as a static webpage. Upgrading of the middleware, back-end program, and front-end program still follows the sequence of middleware—back-end program—front-end program. In existing technologies, these phases totally rely on manual configuration, and the installation packages downloaded include full contents; this content redundancy results in a low upgrading efficiency.

In existing technologies, tools for automatically installing a cache cluster, which are triggered by manually clicking a button, have been mature. For example, RedisManager is a one-stop Redis management platform, which supports monitoring, installation (except sentinel), management, alarm, and basic data operations of a cluster (cluster, master-replica, sentinel), the main features of which include:
Cluster Monitoring, which supports monitoring of important indicators of Redis such as Memory, Clients, etc. and allows real-time viewing of Redis Info, Redis Config, and Slow Log;
Cluster Creation, which supports Docker, Machine, Humpback;
Cluster Management, which supports functions such as node Forget, Replicate Of, Failover, Move Slot, Start, Stop, Restart, Delete, and Configuration Modify, etc.;
Cluster Alarm, which supports indicators such as Memory, Clients (identical to the Monitor indicators) and supports alarms for emails, Business WeChat APP, Business WeChat Webhook, DingTalk; and
Tool Kit, which supports Query, Scan, and basic data operations.

However, such tools still rely on manual clicking of a button to trigger automated installation of the cache cluster; if they are directly used, crash still likely occurs after download via docker mirror; the script of the run container also needs to be manually set; otherwise, the tool cannot start without loading the database configuration. If the database configuration is improperly set, parameters following the database URL might be unrecognizable, directly reporting an error.

In contrast, the disclosure performs system upgrading based on an updated and templated run-time configuration, which realizes template-based automatic configuration via existing tools, whereby phases of manual setting are eliminated.

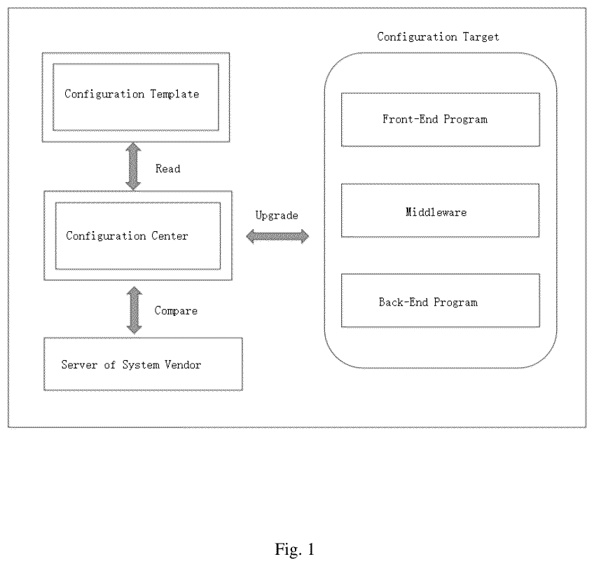

The disclosure is exemplarily applied to upgrade an internal software system of a bank or a securities company, as illustrated in FIG. 1. With increase of business demands, the internal business software system, which is purchased from a system vendor and has served for a certain time, is to be upgraded. For each device in the internal network system, an existing configuration template of the business software system hosted therein is obtained first. The method comprises: obtaining a configuration template from a runtime configuration of a business software system, updating a format of the configuration template, and replacing the updated configuration template with a live runtime configuration; and performing system upgrading based on the updated and templated runtime configuration.

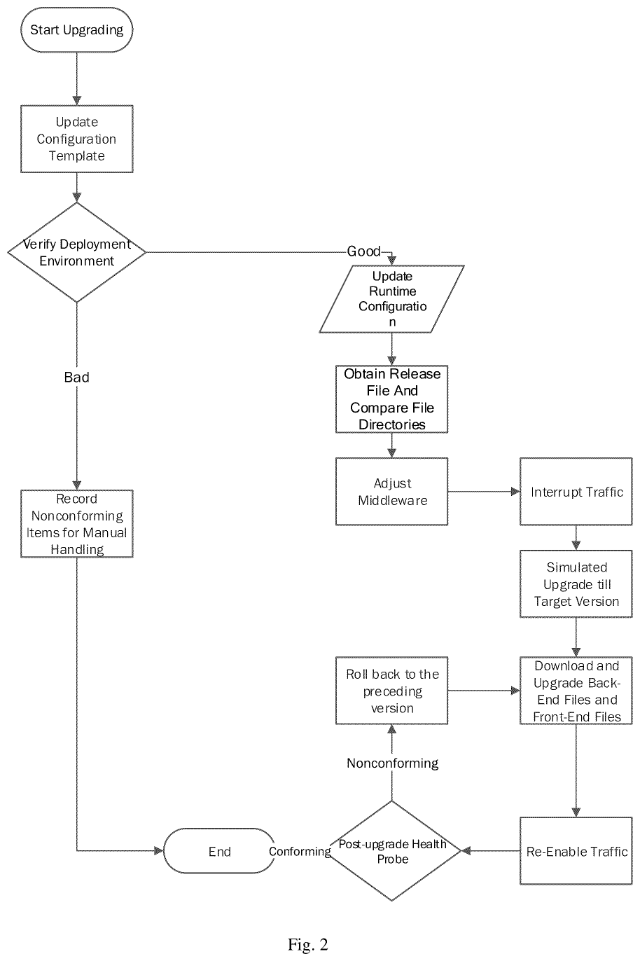

FIG. 2 illustrates a basic flow of the disclosure, where a host in the internal network system is designated as the configuration center to perform system upgrading across the internal network. The configuration center may also be a device to be upgraded. Firstly, the deploy environment of the device where the business software system is hosted is detected and analyzed to obtain the configuration template of the device; the configuration template is checked, and the format of the configuration template is unified and updated. It is noted that unifying and updating the format of the configuration template is not a repetition of the operation of updating the format of the configuration template in a template configuring procedure. In the procedure of updating the format of the configuration template, the configuration template is simply obtained from the runtime configuration of the running business software system, with the format being adjusted; therefore, at this phase, the runtime configuration needs to be backed up, such that once the format of the configuration template is modified, if a problem arises when the updated configuration template is replaced with the live runtime configuration, the problem can be fixed in time. Thereafter, during the upgrading procedure, the deployment environment of the device where the business software system is hosted is detected and analyzed. When obtaining the configuration template of the device where the business software system is hosted, it is not restricted merely to obtaining the contents of the runtime configuration. Thanks to the safeguards provided by the preceding operations, basically no problem would occur to the current updating, thereby ensuring reliability of the updating.

Upon completion of the template configuration, a release file is obtained based on the upgrade of this time, and verified; technical components are provisioned, where in the case of middleware adjustment, a likely-to-be-used script is upgraded based on the updated configuration template; the configuration center is subjected to configuration write-back via a script, where the configuration write-back serves to apply the configuration template of a set device as a sample to other similar devices, which can reduce the time for subsequently upgrading remaining devices. Upon completion of the write-back, to-be-upgraded back-end program file and front-end program file are accurately found by comparing the local file directory of the to-be-upgraded device with the file directory in the release file. Then, the back-end program and the front-end program are sequentially downloaded and upgraded; upon completion of the upgrading, health detection is performed to the upgraded deployment environment. If the upgraded deployment environment satisfies health criteria, it is indicated that the device is successfully upgraded.

Two upgrading options are generally provided in existing technologies: the first solution is to connect the intranet host as the configuration center to the server of the system vendor and then download a corresponding upgrade package as per version information to conduct upgrading; the other solution is directed to a deployment environment where external connection is disabled, where configuration tools and static files and the like for the upgrade are completely copied, via a memory device, to the internal software system of the enterprise for being installed. Hereinafter, the automatic deployment method for upgrading a client's internal business software system according to the disclosure will be described via specific examples with respect to the two options, respectively.

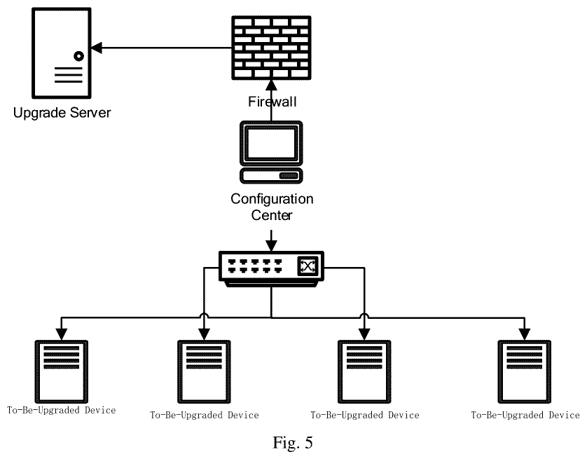

Example 1: Deployment Environment Enabled for an External Network. Generally, even in such an environment, not all hosts are enabled for the external network; instead, one firewall-enabled administration host is enabled for the external network, where the configuration center is set on the administrative host to serve upgrading of all devices connected in the intranet. FIG. 5 illustrates an example embodiment of upgrading an internal business software system of a bank, where the system is installed on the intranet of a branch of the bank, which is connected to the external network only via one host. In this case, the host enabled for external connection serves as the configuration center.

In this environment, the host as the configuration center may be directly connected to an upgrade server of the system vendor. The upgrade server first transmits a configuration tool to detect and analyze the deployment environment where the business software system is hosted. The detecting and analyzing procedure comprises verifying the deployment environment to confirm that it is the deployment environment where the business software system of an authenticated client is hosted. This is to avoid upgrading the business software on a device not entitled to the service, thereby preventing loss to the system vendor. The version information of the existing business software system in the deployment environment is obtained by version detection, from which the workload of system upgrading may be determined. Pre-upgrading health detection is conducted to confirm that the existing business software system runs normally, ensuring that the subsequent upgrading will proceed in a healthy environment, thereby avoiding upgrade failure due to environment reasons.

Existing technologies provide different criteria for environment health. It is generally believed that all existing faults should be eliminated for the sake of smooth upgrading. However, in this example, the entire network has served for over ten years, and the devices have become outdated. If the entire system experiences a heavy load, network disconnection would occur every 20 to 30 minutes. The costs of replacing these devices would be high and the term for system upgrading would be suspended. By pre-upgrading health detection, this fault can be identified via a log file retrieval system. Since network connection is a guarantee to smooth upgrading, a network maintenance tool is provisioned on the upgrade server of the system vendor. This network maintenance tool enables automatic connection within 10 seconds upon network disconnection. The testing verifies that with this reconnection feature, network disconnection would not impact upgrading of the business software system. Therefore, although the network disconnection issue cannot be overcome, it may be still deemed that health degree of the deployment environment meets the criteria.

During the this upgrading procedure, 4 devices in the deployment environment are to be upgraded, where the OA (office automation) system in each device is to be upgraded from version 1.5 to version 3.0. In a case that only a part of the business software systems are to be upgraded, the technician would input the information of the to-be-configured devices in the configuration center and then select the corresponding business software systems hosted on the devices; the configuration center automatically detects the versions of respective business software systems currently running on the devices; the current versions of the business software systems which substantially run healthily would be displayed on the user interface; and then the technician manually selects the target upgrade version.

Next, the deployment environment of each device where the business software system is hosted is detected and analyzed; existing configuration template of the business software system is obtained. A configuration template updating procedure comprises: obtaining a configuration template from the runtime configuration of the business software system, updating a format of the configuration template, and replacing the updated configuration template with a live runtime configuration. An upgrading procedure comprises: detecting and analyzing the deployment environment where the business software system is hosted; updating the runtime configuration based on the configuration template; obtaining a release file, where in a case of middleware upgrading, the existing runtime configuration of the business software system in the deployment environment and the middleware-related configuration are compared with a middleware portion of the configuration file in the directory of the release file to update a value of the configuration template; executing a database script included in the release file;
writing back the configuration, transmitting the configuration information to the configuration center and making it effective, and identifying front-end program files and back-end program files for the upgrading by comparing static directories of pre-upgrading and post-upgrading versions; accurately downloading the files used for the upgrading based on the configuration information, and then performing upgrading; upon completion of the upgrading, subjecting the deployment environment to health detection again, and saving the configuration template of the current time of upgrading if the detection result satisfies criteria. The deployment here is implemented on a single device; therefore, by saving the configuration template on the device, most of the configurations may be inherited on other devices of the same model.

A specific method of unifying and updating the format of the configuration template in the above procedure comprises: obtaining the existing configuration template in the deployment environment based on the live runtime configuration. The runtime configuration refers to a reloadable configuration including a local file.

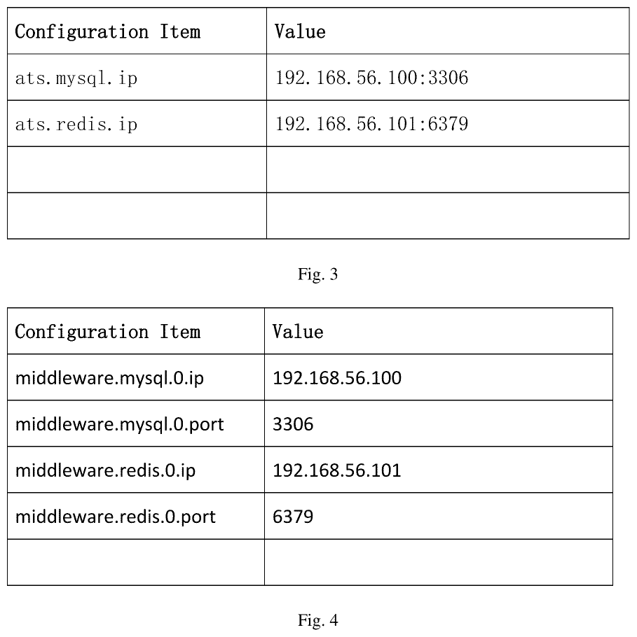

The existing configuration template is parsed to identify the configuration format thereof, which is identified as the KEY-VALUE format shown in FIG. 3. This configuration format needs to be modified, where the configuration items in the configuration format are modified to the configuration template with a structure of “category of configuration business—type of configuration database—number of configuration database—attribute of configuration value”, as illustrated in FIG. 4.

Configuration items with a prefix {middleware/business/ . . . }.{mysql/redis/ . . . }.{0/1/2 . . . }.{ip/port} indicate that: the category of configuration business is middleware or business item or other; the type of configuration database is MySQL or Redis or other; the number of configuration database refers to the serial number of a specific database when a plurality of databases of the same type are present; and the attribute of the configuration value refers to the IP address or Port number or other. The configuration template is updated with such a configuration structure.

Since the disclosure is configuration-driven and performs the entire upgrade plan based on the runtime configuration template, the precondition for implementing the disclosure is that the live runtime configuration of the deployment environment has been modified with the structure noted supra; without such modification, no business software system can be upgraded according to the disclosure.

After the release file is obtained, the deployment environment of the business software system is further subjected to load balancing; before starting the deployment, the redundant application traffics are cut off via the gateway; upon completion of the upgrading, load balancing is performed again at the end of health detetion with respect to the deployment environment, and then the application traffics are resumed.

In this example, the business software system is upgraded from version 1.5 to version 3.0, omitting a plurality of intermediate versions. Therefore, a cross-version accelerated upgrading method may be enabled, specifically comprising:
simulating, at the database end, the upgrade sequentially as per version number via a SQL script, where the modification is made in the configuration file each time, and the script to use is recorded, without executing the script till the target version. In this case, the script of the target version and the pre-request script for executing the script are directly used, omitting the repetitive, redundant, or invalid scripts. For example, if a function is added in version 2.0 but canceled in version 2.2, relevant scripts corresponding to the function are not executed in final upgrading of the configuration.

Likewise, the front-end program and the back-end program are subjected to simulated deployment in the upgrading procedure, where the current version is recorded before upgrading, and then the updated file of each time of upgrading are sequentially recorded as per version number till the target version; a list of changed static files are obtained by comparing the records, whereby these static files are downloaded to physically deploy the final version. This can save significant resources and time.

Upon completion of the upgrading, the upgraded deployment environment is subjected to health detection. If no problem is detected from the health detection, it indicates that the system upgrade is done.

In this case, to upgrade a business software system with the same workload, the conventional approach requires downloading the entire set of system files, the upgrade packages of which would have a total size of over 3G, and the total time taken for downloading, deploying, and testing would exceed 5 hours. However, with the technical solution described herein, the finally downloaded program of about 600-700 M suffices to satisfy the upgrade demands, and the upgrade duration is also controlled at about half an hour. The performance is improved significantly.

Example 2: this example also relates to upgrading an internal software system of a bank, the system being hosted on the intranet of a branch of the bank, where one host is enabled for external connection. In this example, the entire network has served much longer and corresponding devices are more outdated. When the whole system is under a heavy load, network disconnection would occur every five minutes. This fault is detected via a log file retrieval system during pre-upgrading health detection. Network connection is a guarantee to smooth upgrading; although a network maintenance tool is provisioned on the upgrade server of the system vendor, the testing shows that network disconnection still occurs frequency after reconnection, impacting upgrading of the business software system. Therefore, it is deemed that the health degree of the deployment environment cannot meet the upgrade criteria, but may satisfy routine application requirements. In this scenario, the business software system may be upgraded via a verified mobile storage medium.

It is noted that, if it is determined that the health degree of the deployment environment cannot satisfy the upgrade criteria and cannot satisfy routine application requirements either, the nonconforming items are recorded for manual handling. Then, the upgrade work is terminated.

During this upgrading procedure, 2 sets of devices in the deployment environment are to be upgraded, where the identity management system on each device is to be upgraded from version 2.0 to version 2.5. Since such upgrade does not require external network connection, the devices themselves serve as a configuration center. In this case, the configuration template, in which the business software system is hosted, is manually configured for each device. The configuration template is checked; the format of the configuration template is unified and updated; a release file is obtained and checked; the technical components are prepared by: adjusting the middleware, upgrading the likely-to-be-used script based on the updated configuration template; performing configuration write-back on the configuration center via the script; upon completion of the write-back, upgrading the back-end program and the front-end program sequentially; upon completion of the upgrading, subjecting the upgraded deployment environment to health detection.

The specific method of unifying and updating the format of the configuration template is identical to example 1. In this example, the business software system is upgraded from version 2.0 to version 2.5, omitting a plurality of intermediate versions. The configuration template is stored in a mobile memory device. The mobile memory device is physically, e.g., carried by the operator, accessed to the upgrade server of the system vendor. Here, the configuration files are subjected to simulated upgrade on the upgrade server of the system vendor sequentially as per version number via the SQL script, i.e., the modification is made in the configuration file each time; the script to use is recorded, but not executed till the target version. In this case, the script of the target version and the pre-request script for executing the script are directly used, omitting the repetitive, redundant, or invalid scripts. In the upgrading procedure, the front-end program and the back-end program are subjected to simulated deployment, i.e., the current version is recorded before upgrading, and then the updated files of each time of upgrading are recorded sequentially as per version number. In the simulated upgrade procedure, the configuration template for each upgrade and the deployment status of static files are saved by snapshots, and each time of upgrading references the snapshot of its preceding time of upgrading, finally reaching the target version; all snapshots in the upgrading procedure are reserved.

Finally, based on the list of static files, the static files are downloaded from the upgrade server of the system vendor to the mobile memory device. The mobile memory device is then re-connected to the host to be upgraded; in this way, the final upgrade is accomplished automatically based on the configuration file and the static files.

In the copying procedure, it is found from comparison between the file directories that a functional component has been separately installed in one device thereof by its proprietor, while this functional component is also added in the new version of the business software system. This situation can be detected when comparing the file directories. In final upgrading of the device, the installer corresponding to this functional component will not be downloaded, thereby saving upgrading time and space.

In the upgrading procedure, the operation log is real-time displayed on a user interface of the device, and if a problem is detected in a corresponding detection phase, the operation is suspended, and the upgrade tool is pending at the instant phase and an alarm is triggered;

a technician may judge the faulty phase based on the log and take the following measures based on the records in the log and actual conditions of the deployment environment:
1) for a known problem, continuing the deployment upon completion of manual repairment;
2) for an unknown problem or a critical problem, rolling back to the upgrading phase to resume the last phase with a healthy deployment environment.

In this way, automatic upgrade of the business software system is enabled.

Although the disclosure has been described via preferred examples, they are not intended for limiting the scope of implementation of the disclosure. Any person of ordinary skill in the art may make some modifications without departing from the scope of the disclosure; any equivalent modifications to the disclosure shall be included in the scope of the disclosure. In the description of the disclosure, the depiction referring to the terms such as “an embodiment/implementation,” “some embodiments/implementations,” “an example,” “a specific example,” and “some examples” means that the specific features, structures, materials, or characteristics described in the embodiment/implementation are included in at least one embodiment/implementation of the disclosure. In the description, schematic expressions of the terms do not necessarily refer to the same embodiment/implementation. Moreover, the specific feature, structure, material or characteristic as described may be combined appropriately in any one or more embodiments/implementations. In addition, without contradiction, those skilled in the art may integrate and combine the different embodiments/implementations or examples as well as features of different embodiments/implementations or examples described herein.

In addition, the terms “first” and “second” are only used for description purposes, which should not be understood as indicating or implying a relative importance or implicitly indicating the number of the referred to technical features. Therefore, a feature modified with the “first” and “second” may explicitly or implicitly includes at least one feature. In the description of the disclosure, “plurality” means at least two, e.g., two or three, unless otherwise specifically limited.

Those skilled in the art should understand that the embodiments described above are set forth for illustrating the disclosure clearly, but not for limiting the scope of the disclosure. To those skilled in the art, other variations or modifications may be made based on the disclosure above, while such variations or modifications still fall within the scope of the disclosure.

I/We claim:

1. An automated deployment method for upgrading a client's internal business software system, comprising:
obtaining a configuration template from a runtime configuration of a business software system, and unifying and updating a format of the configuration template, wherein a specific method of unifying and updating the format of the configuration template comprises:
obtaining an existing configuration template from the runtime configuration of the business software system;
parsing the existing configuration template to identify a configuration format thereof;
determining, in a case that a configuration item in the configuration format is of a structure “class of configuration business—type of configuration database—number of configuration database—attribute of configuration value”, that the configuration template has been updated; otherwise, modifying the configuration item in the configuration format to the configuration template with the structure “class of configuration business—type of configuration database—number of configuration database—attribute of configuration value”;
replacing the updated configuration template with a live runtime configuration; and
upgrading the internal business software based on the live runtime configuration; wherein the upgrading comprises:
detecting and analyzing a deployment environment where the business software system is hosted;
updating the runtime configuration based on the configuration template;
obtaining a release file, wherein in a case of middleware upgrade, the existing runtime configuration of the business software system in the deployment environment and a middleware-related configuration are compared with a middleware portion of a configuration file in a directory of the release file to update a value of the configuration template;
executing a database script included in the release file;
writing back configuration, transmitting configuration information to the configuration center, making the configuration information effective, identifying a front-end program file and a back-end program file for the upgrading by comparing pre-upgrading static directory and post-upgrading static directory; downloading files used for the upgrading accurately, and then performing upgrading;
subjecting the deployment environment to health detection upon completion of the upgrading; and
saving, in a case that a detection result satisfies health criteria, the upgraded configuration template.

2. The automated deployment method for upgrading a client's internal business software system according to claim 1, wherein a cross-version accelerated upgrading method is further enabled, comprising:
performing, at a database end, simulated upgrading sequentially as per version number via a SQL script till a target version, wherein a script of the target version and a pre-request script for executing the script are directly used, thereby omitting repetitive, redundant, or invalid scripts;
wherein during the upgrading, a front-end program and a back-end program are subjected to simulated deployment, wherein recording their current version numbers before the upgrading, recording files updated at each time of upgrading as per version numbers till the target version, obtaining a list of changed static files by comparing the records, and then downloading the static files to physically deploy the target version.

3. The automated deployment method for upgrading a client's internal business software system according to claim 2, wherein during the simulated upgrading, the configuration template and deployment status of the static files of each time of upgrading are saved by snapshots, and each time of upgrading references the snapshot of its preceding time of upgrading; all snapshots are saved during the upgrading and deleted upon completion of the upgrading and health detection.

4. The automated deployment method for upgrading a client's internal business software system according to claim 1, wherein the detecting and analyzing a deployment environment where the business software system is hosted comprises: verifying the deployment environment to confirm that it is the deployment environment where the internal business software system of an authenticated client is hosted; performing version detection to obtain version information of the existing business software system in the deployment environment; and performing pre-upgrading health detection to confirm that the existing business software system runs normally.

5. The automated deployment method for upgrading a client's internal business software system according to claim 4, wherein during the pre-upgrading health detection with respect to the business software system, a known fault in the system is retrieved via a log file, and the known fault, after being digitalized, is compared with capability of an automatic repair program deployed for the current time of upgrading so as to accurately determine health degree of the deployment environment, wherein in a case that the health degree does not meet criteria, the known fault is repaired before upgrading.

6. The automated deployment method for upgrading a client's internal business software system according to claim 1, wherein in a case that a plurality of devices are present in the deployment environment and a plurality of business software systems are hosted on each device, while what are to be upgraded are a part of the business software systems, after the configuration template is updated, an upgrade tool is run, device information of the devices to upgrade is inputted, and then the business software systems to be upgraded on the devices are selected; the upgrade tool automatically detects version information of currently running business software systems; the business software systems to be upgraded as well as target version numbers are selected by a technician; after the deployment environment passes the health detection, the upgrade tool starts upgrading respective business software systems one by one.

7. The automated deployment method for upgrading a client's internal business software system according to claim 1, further comprising performing load balancing on the deployment environment of the business software system after obtaining the release file, wherein traffics of middleware and back-end programs in the business software system are interrupted before deployment starts; the traffics are monitored during upgrading to guarantee that no traffics are generated by the middleware and the back-end programs; and the traffics are re-enabled upon completion of the upgrading and end of the heath detection with respect to the deployment environment.

8. The automated deployment method for upgrading a client's internal business software system according to claim 1, wherein in a case that the deployment environment is disabled from an external network, the configuration template is updated via a mobile memory medium, and then corresponding static files are copied from a system vendor based on the updated configuration template.

9. The automated deployment method for upgrading a client's internal business software system according to claim 1, wherein the automated deployment method further comprises troubleshooting, wherein during the upgrading, an operation log is real-time displayed on a user interface of the configuration center, such that once a problem is detected in a respective detecting procedure, upgrading is suspended, the upgrade tool is pending instantly, and alarm is triggered;
wherein a faulty phase is identified by a technician via the log, and one of options set forth below is selected based on log records and actual conditions of the deployment environment:
for a known problem, continuing deployment upon completion of manual repair;
for an unknown problem or a critical problem, rolling back to upgrading phase to recover the status recorded by the preceding snapshot and terminating the upgrading.
